(19) United States
(12) Patent Application Publication
(10) Pub. No.: US 2016/0304100 A1
(43) Pub. Date: Oct. 20, 2016

(54) METHODS AND SYSTEMS FOR COMPUTING VEHICLE REFERENCE VALUES

(71) Applicant: GM GLOBAL TECHNOLOGY OPERATIONS LLC, Detroit, MI (US)

(72) Inventors: HUALIN TAN, NOVI, MI (US); JOSHUA R. AUDEN, BRIGHTON, MI (US); JASON D. FAHLAND, DAVISBURG, MI (US); DAVID DOMINGUEZ, FARMINGTON HILLS, MI (US)

(21) Appl. No.: 14/688,810

(22) Filed: Apr. 16, 2015

(51) Int. Cl. B60W 50/04; B62D 5/04; B60T 8/18; B60C 23/20; B60W 40/13

(52) U.S. Cl. CPC B60W 50/04; B60C 23/20; B60W 40/13; B60T 8/18; B62D 5/04; B60W 2530/20; B60W 2710/12; B60W 2710/20; B60W 2710/18

(57) ABSTRACT

Methods and systems are provided for controlling a vehicle. In one embodiment, a method includes: receiving, by a processor, data indicating at least one of a tire tread temperature and a force distribution on a tire; determining, by the processor, a vehicle reference value based on the data; and controlling, by the processor, at least one feature of the vehicle based on the vehicle reference value.

### TECHNICAL FIELD

The present disclosure generally relates to vehicles, and more particularly relates to methods and systems for computing vehicle reference values and controlling the vehicle based on the computed vehicle reference values.

### BACKGROUND

Vehicle reference values, such as vehicle yaw rate and lateral velocity, are widely used in vehicle control systems to control the vehicle. The calculations of vehicle reference values are related to the force generation of the tires, and thus are impacted by vehicle load as well as tire tread temperature

Conventional systems consider only vehicle weight as the vehicle load. Under certain conditions, the vehicle weight can vary and the vehicle load may not be accurate. In addition, other forces, such as a significant downforce from an active aerodynamics system, can affect the vehicle load. These variations in the vehicle load are not taken into consideration when computing the vehicle reference values. Similarly, tire temperature is largely ignored in existing vehicle reference value computations.

Accordingly, it is desirable to provide improved methods and systems for computing vehicle reference values. It is also desirable to provide methods and systems for controlling a vehicle based on the computed vehicle reference values. Furthermore, other desirable features and characteristics of the present invention will become apparent from the subsequent detailed description and the appended claims, taken in conjunction with the accompanying drawings and this background.

### SUMMARY

Methods and systems are provided for controlling a vehicle. In one embodiment, a method includes: receiving, by a processor, data indicating at least one of a tire tread temperature and a force distribution on a tire; determining, by the processor, a vehicle reference value based on the data; and controlling, by the processor, at least one feature of the vehicle based on the vehicle reference value.

In another embodiment, a system includes a first module that generates data indicating at least one of a tire tread temperature and a force distribution on a tire. A second module receives the data, determines a vehicle reference value based on the data, and controls at least one feature of the vehicle based on the vehicle reference value.

### DESCRIPTION OF THE DRAWINGS

The present disclosure will hereinafter be described in conjunction with the following drawing figures, wherein like numerals denote like elements, and:

FIG. 1 is a functional block diagram of a vehicle that includes, among other features, a vehicle control system, in accordance with exemplary embodiments;

FIG. 2 is a functional block diagram of a control module of the vehicle control system in accordance with exemplary embodiments; and

FIG. 3 is a flowchart of a method for computing vehicle reference values and controlling the vehicle based thereon in accordance with exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

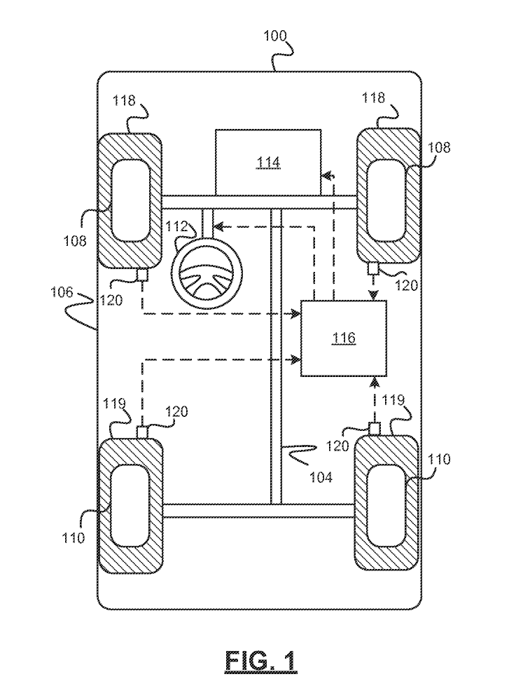

With reference to FIG. 1, a vehicle 100 is shown that includes a vehicle control system 102 in accordance with various embodiments. The vehicle control system 102 generally computes one or more vehicle reference values and controls the vehicle 100 based thereon. The vehicle control system 102 computes the vehicle reference values based on improved methods of computation. For example, an active aerodynamic system can inject extra downforce in the amount from 20% to over 50% of the vehicle weight. Such significant downforce can greatly change the vehicle understeer characteristics and tire force generation. Also, tire temperature may result a variation of force-generation capability from 0.5 g to 1.2 g for the same tire on a dry surface. Thus, the impacts of these factors are directly considered in the improved vehicle reference value computations so that the control systems can function properly.

Although the figures shown herein depict an example with certain arrangements of elements, additional intervening elements, devices, features, or components may be present in an actual embodiment. It should also be understood that FIG. 1 is merely illustrative and may not be drawn to scale.

As depicted in FIG. 1, the vehicle 100 generally includes a chassis 104, a body 106, front wheels 108, rear wheels 110, a steering system 112, a propulsion system 114, and a control module 116. In general, the body 106 is arranged on the chassis 104 and substantially encloses the other components of the vehicle 100. The body 106 and the chassis 104 may jointly form a frame. The wheels 108-110 are each rotationally coupled to the chassis 104 near a respective corner of the body 106. Coupled to each wheel 108-110 is a tire 118-119 having a tread that contacts a road surface.

As can be appreciated, the vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). The vehicle 100 may also incorporate any one of, or combination of, a number of different types of propulsion systems 114, such as, for example, a gasoline or diesel fueled combustion engine, a “flex fuel vehicle” (FFV) engine (i.e., using a mixture of gasoline and ethanol), a gaseous compound (e.g., hydrogen or natural gas) fueled engine, a combustion/electric motor hybrid engine, and an electric motor.

The control module 116 controls one or more features of the vehicle 100. In various embodiments, the control module 116 controls the steering system 112 and/or the propulsion system 114. As can be appreciated, the control module 116 can control various other systems (not shown), in various embodiments. The control module 116 is communicatively coupled to one or more sensors 120. In general, the control module 116 receives sensor signals from the sensors 120, determines one or more control values, and controls the systems 112 and 114 of the vehicle 100 based on the control values.

In various embodiments, the control module 116 determines a tire temperature for each of the tires 118-119, determines a force distribution on each of the tires 118-119, and uses the tire temperature and the force distribution to compute one or more vehicle reference values such as, but not limited to, vehicle yaw rate, lateral velocity, side slip angle, etc. The control module 116 uses the vehicle reference values to control one or more features of the vehicle 100, such as, but not limited to a traction control feature, an anti-lock brake feature, a slip-differential feature, an electric power steering feature, an active-chassis feature, etc.

In various embodiments, the sensors 120 can be tire sensors that senses observable conditions of the tires 118-119 (such as a tire pressure and/or a tire temperature) and that generates sensor signals based thereon. In such embodiments, the control module 116 receives the sensor signals, determines a tire temperature for each of the tires 118-119, and/or determines a force distribution on each of the tires 118-119, and uses the tire temperature and/or the force distribution to compute one or more vehicle reference values.

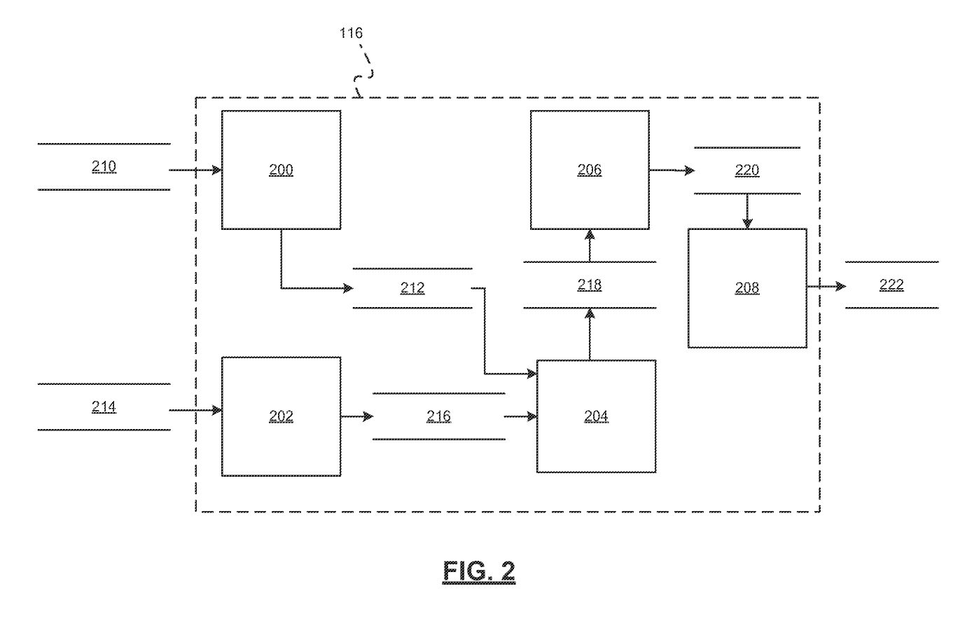

Referring now to FIG. 2 and with continued reference to FIG. 1, a dataflow diagram illustrates the control module 116 of FIG. 1 in accordance with various embodiments. As can be appreciated, various embodiments of the control module 116, according to the present disclosure, may include any number of sub-modules. For example, the sub-modules shown in FIG. 2 may be combined and/or further partitioned to similarly determine vehicle reference values. As discussed above, inputs to the control module 116 may be received from the sensors, received from other control modules (not shown) within the vehicle 100, and/or determined by sub-modules (not shown) within the control module 116. In various embodiments, the control module 116 includes a tire tread temperature estimation module 200, a load distribution determination module 202, a dynamic parameter determination module 204, a reference value determination module 206, and at least one vehicle system control module 208.

The tire tread temperature estimation module 200 receives as input tire data 210 associated with each tire 118-119 of the vehicle 100. In various embodiments, the tire data 210 may be based on the sensor signals generated by the tire sensors 120. The tire tread temperature estimation module 200 estimates a tread temperature 212 of each tire 118-119 based on the tire data 210.

The load distribution determination module 202 receives as input force data 214. In various embodiments, the force data 214 may be predetermined based on characteristics of the vehicle and tire. In various other embodiments, the force data may be determined based on current aerodynamic conditions of the vehicle and characteristics of the tires. Based on the force data 214, the load distribution determination module 202 determines load distribution values 216 indicating downforces exerted on each of the tires 118-119.

The dynamic parameter determination module 204 receives as input the tire tread temperature 212 for each of the tires 118-119 and the load distribution values 216 for each of the tires 118-119. The dynamic parameter determination module 204 computes parameter values 218 based on the tire tread temperature 212 and/or the load distribution values 216. The parameter values 218 include, but are not limited to, a tire cornering stiffness for each of the tires 118-119. In various embodiments the tire cornering stiffness may be computed based on a lookup table that associates tire tread temperatures 212 with cornering stiffnesses, and/or a lookup table that associates load distribution values with cornering stiffnesses.

The reference value determination module 206 receives as input the parameter values 218, among other values. The reference value determination module 206 determines one or more vehicle reference values 220 based on the parameter values 218 and a reference value model. In various embodiments, the reference value model is a bicycle model. An exemplary bicycle model for determining vehicle reference values 220 such as a vehicle yaw rate and a lateral velocity is based on the following relation:

$$\begin{matrix}[ \begin{matrix}{\dot{v}}_{y} \\ \dot{r}\end{matrix} ] = [ \begin{matrix}{a}_{11} & {a}_{12} \\ {a}_{21} & {a}_{22}\end{matrix} ] [ \begin{matrix}{v}_{y} \\ r\end{matrix} ] + [ \begin{matrix}{b}_{11} & {b}_{12} \\ {b}_{21} & {b}_{22}\end{matrix} ] [ \begin{matrix}{δ}_{f} \\ {δ}_{r}\end{matrix} ] , & ( 1 ) \\ {a}_{11} = - \frac{{C}_{f} + {C}_{r}}{{Mv}_{x}} , {a}_{12} = \frac{- {aC}_{f} + {bC}_{r}}{{Mv}_{x}} - {v}_{x} , {b}_{11} = \frac{{C}_{f}}{M} , {b}_{12} = \frac{{C}_{r}}{M} , and & ( 2 ) \\ {a}_{21} = \frac{- {aC}_{f} + {bC}_{r}}{{I}_{z} {v}_{x}} , {a}_{22} = - \frac{{a}^{2} {C}_{f} + {b}^{2} {C}_{r}}{{I}_{z} {v}_{x}} , {b}_{21} = \frac{{aC}_{f}}{{I}_{z}} , {b}_{22} = - \frac{{bC}_{r}}{{I}_{z}} . & ( 3 )\end{matrix}$$

Where vy represents a vehicle lateral velocity (m/s); r represents vehicle yaw rate (rad/sec); vx represents vehicle speed (m/s); δ_{f} represents a front road steer wheel angle (rad); δᵣ represents a rear steer angle (rad); Cf represents front axle cornering stiffness (N/rad); Cr represents a rear axle cornering stiffness (N/rad); a represents a distance from front axle to vehicle center of gravity (m); b represents a distance from front axle to vehicle center of gravity (m); Iz represents a moment of inertia about vehicle z-axis (kg-m²); and M represents vehicle total mass (kg).

In this example, the reference value determination module 206 computes the front axle cornering stiffness based on the cornering stiffness parameters computed for the front two tires 118. The reference value determination module 206 computes the rear axle cornering stiffness based on the cornering stiffness parameters computed for the rear two tires 119. The reference value determination module 206 then computes the vehicle yaw rate and the lateral velocity using the computed front axle cornering stiffness and the computed rear axle cornering stiffness that take into account the tire temperature and the load distribution (via use of the computed parameter values 218). As can be appreciated, in various embodiments, other models and parameters can be used that take into account the tire temperature and the load distribution.

The vehicle system control module 208 receives as input the vehicle reference values 220, for example, including the yaw rate and the lateral velocity discussed above, and controls one or more features of the vehicle 100 based on the vehicle reference values 220. For example, the vehicle system control module 208 generates controls signals 222 (or messages) based on the vehicle reference values 220. As discussed above, the feature of the vehicle 100 can be at least one of a traction control feature, an anti-lock brake feature, a slip-differential feature, an electric power steering feature, an active-chassis feature, etc. As can be appreciated, one vehicle system control module 208 can be implemented for each feature and/or multiple vehicle system control modules 208 can be implemented for multiple features, in various embodiments.

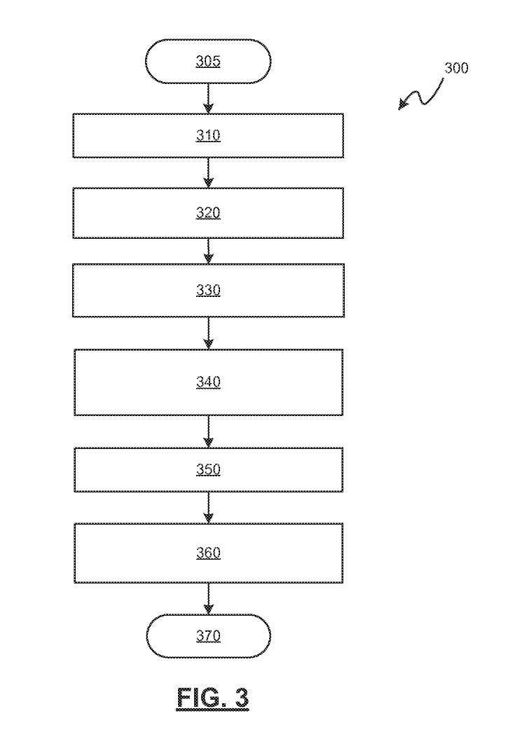

With reference now to FIG. 3 and with continued reference to FIGS. 1 and 2, FIG. 3 is a flowchart of a method 300 for computing vehicle reference values 220 and controlling the vehicle 100 based thereon, in accordance with exemplary embodiments. The method 300 can be utilized in connection with the vehicle 100 of FIG. 1 and can be performed by control module 116 of FIG. 2, in accordance with exemplary embodiments. As can be appreciated in light of the disclosure, the order of operation within the method is not limited to the sequential execution as illustrated in FIG. 3, but may be performed in one or more varying orders as applicable and in accordance with the present disclosure. As can further be appreciated, the method of FIG. 43 may be scheduled to run at predetermined time intervals during operation of the vehicle and/or may be scheduled to run based on predetermined events.

As depicted in FIG. 3, the method may begin at 305. The vehicle data including the tire data 210 and the force data 214 is received at 310. For each tire 118-119 of the vehicle 100, the tire tread temperature 212 is estimated at 320. For each tire 118-119 of the vehicle 100, the load distribution values 216 are estimated at 330. Using the tire tread temperatures 212 and the load distribution values 216, the parameter values 218 are computed at 340. The reference values 220 are computed using the parameters values 218 and the bicycle model (or other model) at 350. One or more vehicle features are controlled based on the reference values 220 at 360 via the control signals 222. Thereafter, the method may end at 370.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method of controlling a vehicle, the method comprising:
receiving, by a processor, data indicating at least one of a tire tread temperature and a force distribution on a tire;
determining, by the processor, a vehicle reference value based on the data; and
controlling, by the processor, at least one feature of the vehicle based on the vehicle reference value.

2. The method of claim 1, wherein the receiving comprises receiving data indicating the tire tread temperature.

3. The method of claim 1, wherein the receiving comprises receiving data indicating the force distribution on the tire.

4. The method of claim 1, further comprising determining a parameter value based on the data, and wherein the determining the vehicle reference value is based on the parameter value.

5. The method of claim 4, wherein the parameter value is a tire cornering stiffness.

6. The method of claim 4, wherein the determining the vehicle reference value is further based on a bicycle model.

7. The method of claim 1, wherein the vehicle reference value is at least one of a vehicle yaw rate and a vehicle lateral velocity.

8. The method of claim 1, wherein the feature includes at least one of a traction control feature, an anti-lock brake feature, a slip-differential feature, an electric power steering feature, and an active-chassis feature.

9. A system for controlling a vehicle, the system comprising:
a first module that generates data indicating at least one of a tire tread temperature and a force distribution on a tire; and
a second module that receives the data, that determines a vehicle reference value based on the data, and that controls at least one feature of the vehicle based on the vehicle reference value.

10. The system of claim 9, wherein the first module generates data indicating the tire tread temperature.

11. The system of claim 9, wherein the first module generates data indicating the force on the tire.

12. The system of claim 9, wherein the second module determines a parameter value based on the data, and determines the vehicle reference value based on the parameter value.

13. The system of claim 12, wherein the parameter value is a tire cornering stiffness.

14. The system of claim 12, wherein the second module determines the vehicle reference value further based on a bicycle model.

15. The system of claim 9, wherein the vehicle reference value is at least one of a vehicle yaw rate and a vehicle lateral velocity.

16. The system of claim 9, wherein the feature includes at least one of a traction control feature, an anti-lock brake feature, a slip-differential feature, an electric power steering feature, and an active-chassis feature.

17. A vehicle, comprising:
front tires;
rear tires;
a first module that generates data indicating at least one of a tire tread temperature or each of the front tires and the rear tires and a force distribution on each of the front tires and the rear tires; and
a second module that receives the data, that determines a vehicle reference value based on the data, and that that controls at least one feature of the vehicle based on the vehicle reference value.

18. The vehicle of claim 17, wherein the second module determines a parameter value based on the data, and determines the vehicle reference value based on the parameter value.

19. The vehicle of claim 18, wherein the second module determines the vehicle reference value further based on a bicycle model, and wherein the parameter value is a tire cornering stiffness.

20. The vehicle of claim 19, wherein the vehicle reference value is at least one of a vehicle yaw rate and a vehicle lateral velocity.
